(19) United States
(12) Patent Application Publication
(10) Pub. No.: US 2014/0372243 A1
(43) Pub. Date: Dec. 18, 2014

(54) Live Auction System

(71) Applicants: Larry Ciulla, Gloucester, MA (US); William Frontiero, Gloucester, MA (US)

(72) Inventors: Larry Ciulla, Gloucester, MA (US); William Frontiero, Gloucester, MA (US)

(21) Appl. No.: 13/920,107

(22) Filed: Jun. 18, 2013

(51) Int. Cl. G06Q 30/08

(52) U.S. Cl. CPC G06Q 30/08
USPC 705/26.3

(57) ABSTRACT

A decrementing live online auction system is provided. The auction system is capable of handling any number of potential buyers bidding on one or more items in one or more auctions. The system may be implemented on a computer and accessible by users on computers. This system may be accessible to a user even with a slow and intermittent internet connection, such as a user on a cellular network connection.

### BACKGROUND OF THE INVENTION

1. Field of the Invention

The present invention relates generally to online auctions. More particularly the present invention relates to an online auction system that allows any number of users to access the auction simultaneously in real time.

2. Description of Related Art

Online auction systems are seen in many embodiments.

Online auction systems are desirable because they are efficient ways to allow buyers and sellers to seek an efficient market price for items. They also bring buyers and sellers together over great distances. Generally, online auction systems are time-driven such as Ebay®, or bandwidth heavy, count-up systems that require constant data communication between the bidders and auctioneer. The bandwidth requirements make it so that only a limited number of bidders may participate in the online auction. Shortcomings of time-driven auction systems such as Ebay® are that they cannot move large quantities of items quickly, because time must be allowed for the bidding to rise up to market value.

Therefore, what is needed is a live online auction system that allows an unlimited number of users to access the live auction, and that allows for live bidding for quick sale of product.

### SUMMARY OF THE INVENTION

The subject matter of this application may involve, in some cases, interrelated products, alternative solutions to a particular problem, and/or a plurality of different uses of a single system or article.

In one aspect, a live online auction method is provided. The method involves providing user access to an auction taking place in an online auction room to a plurality of users. Each of these users will access this auction room through a computerized interface. In the auction room, users may view a catalog and the current bid price of an item being auctioned. The catalog comprises a quantity of information regarding each of a plurality of items to be auctioned. Further, users may bid on an item currently being auctioned. Users may further enter pre-bid amounts for any of the items listed in the catalog before the item is up for bidding.

An auctioneer in computerized communication with the auction room controls the auction and auction room. The auctioneer inputs information into a computerized auctioneer interface and controls the progression of the auction. Information input and controlled by the auctioneer may include, but is not limited to: inventory information, initiating the auction, item up for bidding, decrement rate and amount, starting price, and when to initiate the decrementing for the item up for auction. As an item is auctioned, the price of the item is decremented. During auctioning, a first bid from one of the plurality of users that is received by the system providing the auction room is the winning bid. Once this bid is received, the auctioneer is informed, the auctioning of the item up for bid ends, and a new item is brought up for bidding, continuing the auction.

In another aspect, a system of live online auctioning is provided. The system comprises a host server providing an auction room accessible to any number of potential bidders and/or an auctioneer. The auction room is presented as a computerized user interface that provides information regarding an auction, such as a price, and price status of an item up for bidding, along with details regarding the different items up for auction. Further, the host server is configured to control the auction of these items. A plurality of user computers are in communication with the host server, each user computer configured to access the auction room provided by the host server. Further, each of the plurality of user computers is configured to provide a bid input to the host server. Upon receipt of a first bid input from a bidder, the host server is configured to end the decrementing of the price of the item up for bid, award it to the bidder, and bring a next of the plurality of items up for bid. These steps after receiving the bid may be performed by a computerized or human auctioneer.

In yet another aspect, a computerized method of purchasing an item through a live online auction system is provided. The method begins with accessing the live online auction system by a user using a computer. Once accessed, the user may select an auction room from a plurality of different auction rooms of the live online auction system. Each auction room provides access to an auction of different items. Within this auction room interface, the user may use the computer to view a catalog which has a description of each of a plurality of items up for auction. The auction room interface further allows a user to input a pre-bid amount on one of the items listed in the catalog. The pre-bid is used to automatically bid on an item when it reaches the pre-bid amount. Further, the user may bid on an item up for auction by entering a bid once the price shown for the item has decremented to a value that the user is willing to pay, though there is a chance another buyer may enter a bid at a higher price. Upon entering the bid, and its receipt by the system, assuming no other bid has been received by the system first, the user is awarded the item at the bid price entered. This price is then paid, and the user receives the item.

### BRIEF DESCRIPTION OF THE DRAWINGS

FIG. 1 provides a flow chart of an embodiment of a buyer side of the auction system.

FIG. 2 provides a flow chart of an embodiment of an auctioneer side of the auction system.

FIG. 3 provides a flow chart of an embodiment of the auction system.

FIG. 4 provides a flow chart of another embodiment of the auction system.

FIG. 5 provides a flow chart of yet another embodiment of the auction system.

FIG. 6 provides flow chart of an embodiment of the pre-bid operation of the auction system.

FIG. 7 provides a flow chart of still another embodiment of the auction system.

### DETAILED DESCRIPTION

The detailed description set forth below in connection with the appended drawings is intended as a description of presently preferred embodiments of the invention and does not represent the only forms in which the present invention may be constructed and/or utilized. The description sets forth the functions and the sequence of steps for constructing and operating the invention in connection with the illustrated embodiments.

Generally, the present invention relates to a live decrementing online auction system. The auction system is capable of handling any number of users who may be seeking to bid on one or more items in one or more auctions. The system may be implemented on a computer and accessible by users on computers in a native browser setting, i.e. without a special application or plug-in. Additionally, this system may be accessible and operable to a user even with a slow and intermittent internet connection, such as a user on a cellular network connection.

The live online auction system contemplated herein is configured to harness excitement of users, provide instant gratification to winning bidders, be implemented in an easy to use user interface, and be highly useful in driving traffic to any web site or interface it is implemented on.

The computerized devices on which the system may be employed may include, but are not limited to: desktop computers, laptop computers, internet enabled mobile devices such as tablets or smart phones, iPod®, and the like. The system may be implemented through a traditional web browser, or may be configured as a mobile application for a mobile device, in a cloud based or cloud deployable environment, or may be implemented as a Facebook® or similar social networking application or other social media add-on, among others.

The auction system contemplated herein provides a number of interfaces for different users. For example, a bidder may access and utilize the system using a bidder interface; a seller may access, manage, and utilize the system using a seller interface; and an auctioneer may access and utilize the system using an auctioneer interface. Moreover, the auction system may be implemented in a software-as-a-service embodiment wherein clients may utilize the software and management service as needed. Further, the auction system is scalable and customizable, allowing a large scale seller to implement the system to sell a large quantity of inventory, allowing an auction house to run its auctions, and/or allowing a website to allow individual users to buy and sell, among many options. The auction system may be used to auction off any item or items.

The system may require that users set up an account, or may allow new users to operate as a guest. In some embodiments. Certain auctions may require a pre-approval to enter such as a line of credit qualification, or certification. For these auctions, user log in will likely be required, the user account being capable of storing user pre-approval information, among other things.

User accounts may further comprise information such as stored credit cards, bank information, contact information, user purchase history, auction viewing history, and the like. In some embodiments, user information may be processed by the system for information for system administrators, as well as for use in targeting the user with advertisements and suggestions of items and auctions they may be interested in.

When a user enters a home page, they may view auctions that are currently taking place, as well as unsold items, and/or future auctions. The view may provide a brief description of the auctions such as category, date, time and the like. These auctions may be categorized in any manner such as by category, by time, by pre-qualification limit, and the like. For a logged in user, the system may automatically display suggested auctions to a user.

In further embodiments, a quantity of demonstration videos, audio, explanations, or other media may be provided. The demonstration media may inform users on how to use the system, its features, and the like.

In one embodiment, the system is implemented as a count-down, or decrementing auction. As such, an item up for bidding begins at a high price and decrements at a set interval until a bidder user enters a bid. The first bid received by the system for the item awards the item to the bidder immediately at the bid price, and stops the auctioning of the item. The next item up for bidding in the auction is then auctioned in the same way. In this way, the system contemplated herein is offer driven, and uses price, not time, as the determinant of when the auction for a particular item ends. In short, the system is configured to automatically accept the first offer (bid) to buy the item that is received; causing user offers to drive the auction.

One aspect of the system provides a bidder side implementation. In this implementation, a user may set up an account or access the auction as a guest. Certain auctions such as a high end art auction may have a higher level of exclusivity than an auction for a TV, vehicle, or consumer good. As such, the system may allow a user to pre-qualify for auctions at certain levels and item costs. The pre-qualification may be done in any way including, but not limited to: credit checks, proof of credit limit or funds, lines of credit levels, credit card limit levels, cash deposits, bonds, and the like. Other auctions may require users to provide certifications or credentials such as wholesale diamond or vehicle auctions, for example.

Once a bidder selects an auction they would like to view, they can enter an “auction room” interface. The auction room interface provides a catalog of the items up for bidding, an interface to enter a bid, and a display of an item being bid on and its price. The catalog provides brief and/or detailed descriptions of the products that are or will be up for bid, along with optional photos and/or video. In one embodiment, the catalog and detail may be accessible from the auction room page. In another embodiment, a brief description of the items up for bid may be accessible from the auction room page, while a detailed catalog view may be accessible in a different window, dropdown menu, separate browser tab, or separate interface. In still another embodiment, the catalog may be searchable or filter-able to help users narrow down items of interest. In yet other embodiments, the display of the items up for bid may be separate from the item being currently bid on, and some or all of the information on the item being bid on may be displayed, or may be displayable.

Once a user has entered the auction room, they may view the catalog of items to be auctioned and may place a pre-bid on any of the items. In one embodiment, the system may limit the number of items that can be pre-bid on, or may allow any number of items to be pre-bid. In a further embodiment, the system may be configured to cancel pre-bids if a user wins an item auctioned before the item having the entered pre-bid, though this is not required. Pre-bids may be displayed to a user by a visual indicator such as a colored highlight of the item, an indicator that the pre-bid is activated, and the like.

The pre-bid may be implemented in any number of manners. A key aspect to entrance of the pre-bid into the system is allowing a user to select the item, and input the pre-bid value they would like to enter. This input may be performed on the auction room main display, in a separate interface, separate window, or the like. In one embodiment, the pre-bid locks in once the item having the pre-bid is up for bidding.

In a situation where there is more than one pre-bid entered at the same price for an item, the system is configured to identify the first entered pre-bid and award the item to that user if the price reaches the pre-bid amount.

In one embodiment, if a user's pre-bid is above the starting bid amount for a user, the user may automatically win the item. In another embodiment, if the auctioneer (either computerized or human) identifies that a pre-bid is above the starting bid amount, the auctioneer may raise the starting bid to be above the pre-bid amount. For example, the system may automatically adjust the start price to be 110% of the highest pre-bid (or other percentage).

The system may allow for a customizable user interface. This customization may be performed by a bidder user, a seller user, an auctioneer user, or system administrator. For example, a seller may wish to set up an auction marketplace that reflects their branding, and mimics an existing interface. The system is capable of such configuration. Similarly, a bidder user may wish to customize an auction room to an interface that they enjoy once logged on, the system is further capable of this type of configuration. Moreover, a seller or auctioneer user may set up a business utilizing the system as a platform and may customize the look and feel of the platform. In this embodiment, the seller or auctioneer user may customize their system implementation to create a distinctive look and feel.

In one embodiment, the system may be configured to allow a seller to sell one or multiple lots of the same item in an auction. For example, often food items are sold in lots by weight. The system may be configured to efficiently sell these lots by listing each lot in an auction room. One lot may go up for bid, and once a user selects a winning bid price, they will win the lot. In one embodiment, the user may elect to buy multiple lots at the bid price, such as ten lots, even though only one lot was bid on. In a further embodiment, multiple lots may be bid on simultaneously. In still a further embodiment, the system may be configured to limit a number of lots that may be purchased (ten, for example), however this is not required. In the multi-lot auction embodiment, once a lot item has been bid on and won, the next lot item is up for bid, until the lot items are all purchased.

The system may further provide a research option. The research option may provide information to a bidder user regarding items up for bid, or listed in a catalog. In one embodiment, this research may be automatically generated by the system. In another embodiment, a user may be given the tools to perform the research.

Examples of automatically generated research information may be any information generated by the system regarding the item to be bid on. For example, the system may identify previously sold items similar or the same as an item in a catalog, and may present this information to the user. In another example, the system may research other internet sales of the product and present that information. This research information may help users make informed bids, and understand what the market is like for items that are the same as, or similar to, what they are bidding on.

As noted above, once an item is up for bidding (also referred to as the “clock item”), it begins at a particular start price and counts down in price in decrements. Once a user sees the item reaching a price they are willing to pay, they may bid on the item. The first user to bid (as received by the system) will win the auction and have bought that item. A next item for bid will then be auctioned. The auction for the next item may begin automatically by the system, or a live auctioneer may initiate the auctioning of the next item manually.

In some embodiments, the system may further provide a chat option. In one embodiment, this chat option may be on an auctioneer side—allowing the auctioneer to send messages to all users. In another embodiment, the user-bidders may chat with each other. In still another embodiment, the user-bidders and auctioneer may all communicate in an open chat system.

In addition to the bidder side of the system, the system further may include an auctioneer side. The auctioneer side is configured to allow an auctioneer to manually control the auction, and provide a different auction environment to bidders from a computerized, automated bidding system. Live auctioneers may be particularly desirable for high cost items, and auctions that are more slowly paced. Further, an auctioneer may partially computerize some or all aspects of each auction and may manage more than one auction.

The auctioneer side of the system may provide full control to the auctioneer for all aspects of the auction. For example, the auctioneer may set and adjust a reserve price, may set a starting bid, decrement rate, decrement amount, may start and stop the auction at any point, may manually bring each new item up for bid and control the timing thereof, communicate with bidders, and the like. Further, the auctioneer may be able to view all pre-bids on all items in the auction catalog.

In some embodiments, the auctioneer may be able to access inventory details through an inventory interface or tab. The inventory interface allows changes to an item's auction parameters such as starting price, quantity of the item, description (detailed and brief), reserve price, category, image selection for the item, and the like. In this interface, if an item goes as unsold, the auctioneer may re-auction it, or transfer it to another auction. If the item sells for a price under the reserve price, the auctioneer may have the capability to override the reserve and sell it at the sub-reserve price.

In another embodiment, wherein the auctioneer is at least partially computerized, a dynamic inventory module may be configured to automatically access for-sale items on an external online sales service and, if the items meet certain criteria, place that inventory into an auction being run on the auction system. This may be implemented by the dynamic inventory module accessing an application programming interface (API) of an online sales service such as Ebay®, Amazon®, or the like.

The dynamic inventory module may identify inventory that meets a certain criteria, and then input that inventory into the auction system to be sold. For example, the dynamic inventory module may have criteria set to identify items on another auction site that did not sell for their reserve price, and automatically input that item and related information into the auction. The same reserve as before may be used, or another reserve or no reserve may be used. Another example of criteria may be to select auction items ending shortly on an auction service that has a set time period until the auction ends. In this embodiment, the dynamic inventory module may automatically input the information gathered from the other auction service and input it into the auction system taught herein. Bidders may bid on the auction item and win the item. In a further embodiment, the dynamic inventory module may identify if a bid on the auction system is higher than a bid on the other auction site, and if so, enter that bid into the other auction site automatically. It should be understood that other criteria may be used to select items from other services by the dynamic inventory module such as identifying unsold inventory, identifying unsold inventory on a time-limited sale services, identifying inventory that fits within particular categories of auctions available, and the like. In still another embodiment, the dynamic inventory module may identify an item for sale at a particular price, set the reserve for that price, and if it is sold for a higher price through the auction system, buy the item at the particular price, provide it to the user who submitted the winning bid, and keep the profit, automatically using the computerized system.

As noted, the auctioneer side may be fully or partially computer automated, allowing the option to automate different parts of the auction. For example, while a live auctioneer may manually decrease the bid at their own pace, in another embodiment, they may set the decrement rate and amount, and allow the system to automatically count the price down. Similarly, while a live auctioneer may manually bring up a next item for bidding, the system may be configured to do it automatically after a set time period after the previous item has been purchased. It should be understood that an auctioneer has full control over the system and may adjust any variable even after it has been set to automatic.

Further, the system may be configured to allow a single auctioneer to manage multiple auctions at one time. For example, an auctioneer may be operating three auctions simultaneously, and may utilize the system to automate different aspects, thereby making the auctions more manageable.

In some embodiments, the system may further be configured with a multiple-auction management interface. This interface may provide flags or other indicators to an auctioneer to alert him or her to the auctions requiring attention. For example, in an embodiment wherein the auctioneer is managing three auctions at once, and manually setting the next items up for bid, an indicator may be presented such as an audio or visual flag that instructs the auctioneer to attend to that auction. These indicators may be set up in a single area such as a window or tab, may be pop up windows, or may be more passive such as a tone or flashing area.

Auctioneers capable of using the system may be varied and range from professional auctioneers, individual sellers, system administrators, and the like. Indeed the system is capable of being scaled and transferred to any environment wherein a user may act as an auctioneer to control at least one aspect of the auction. These auctioneers may be positioned anywhere in the world needing only a computer and internet access.

Those wishing to sell an item or items may also use the system. These sellers are distinguished from an auctioneer because a seller may provide the item for auction to be sold by the system—either automatically or through a human auctioneer. However, in some embodiments, a seller may act as the auctioneer as well.

In varying embodiments, the seller may create their own auction, may make their item available as part of another auction, or may provide their item to a system administrator who may manually or automatically list the item in an upcoming auction. Further, an administrator wishing to use the system may integrate the auction system into a website or other internet interface to allow various sellers to access the interface and post the items they wish to sell.

In further embodiments, the system will comprise host or administrator side interfaces. The administrator interface allows a user to control not only the auction, but also administrative aspects including user profile access and control, interface control, over-ride control on certain purchase and auctions, current, past and upcoming auctions, user complaints, user purchase data, and the like.

In one embodiment, an administrator may view purchase and/or use history of the users. The administrator may configure the system to track trends of purchases of the user, and may use the system to provide targeted advertisements and suggested auctions to the buyer/user. The system may provide reports and similar data to the administrator. Further, this information may be used to send users notifications regarding auctions that they may be interested in. This notification system may be supplemental to a notification system set up by a user.

Notifications may be provided to a user in any medium capable of informing the user. For example notifications may be in the form of pop-ups on a computer, cellular telephone, or mobile device, email, telephone, text message, and the like. The notifications may be related to a particular auction, or may be related to a particular auction item.

Users of any type (buyer, seller, auctioneer, admin) may be provided with an “account information” interface. This interface allows users to view information about their account, including prior history, stored payment information, recent sold or purchased items, auctions participated in, user name, password information, and the like.

Further, in some embodiments, users may be associated with each other, may be configured as sub-users, and the like. For example, if a company wanted to have two authorized buyers, these buyers may have separate user names. However, the different user names may be associated with a single entity, and as such, the different users may access information relating to the other user such as previous purchases, combined payment info, and the like. This configuration may be a part of the sign-up process, and a user may create a sub-user or multiple sub-users.

The auction system contemplated herein may be implemented for any type of auction, and is not limited by any goods type. Examples of products that may be auctioned by the auction system include, but are not limited to: foods—such as fish, grains, produce and the like, estate auctions with a variety of items, art, high end goods, diamonds, cars, and the like. These items may be separated into different categories by the system, allowing those interested in diamonds to view only diamond auctions.

Profit may be generated by the auction system in any number of manners including, but not limited to: taking a percentage from sales, a flat rate per sale item, fees from providing the software as a service, sale of the system, implementation costs, advertising revenue from online traffic, licensing fees, and the like.

It should be understood that the system may be deployed in any number of manners. In one embodiment of deployment, the system may be implemented in a user-accessible website that allows multiple auctions to be run. These auctions may be organized for example by different categories of item type. Users may access the website, identify the type of auction they want to access (car, diamond, wine, estate sale, etc.) and enter the auction rooms to view inventory and participate. These auctions may be run as described above by an auctioneer—either computerized or human, and may use inventory provided by any source.

In another embodiment, the system may present a customized user interface to bidders while utilizing the auction system “under the hood”. In this embodiment, a seller wishing to sell their own products using the auction system may integrate the system into their website or online interface to make the user experience integrated with the rest of the seller's online interface. For example, a large scale retailer may wish to sell last year's model of a product to make space for new inventory. This selling may be performed using the auction system herein, which may be accessible through the seller's website, so that a bidder buyer does not feel like they are leaving the retailer's website.

The above embodiment may be implemented in two ways. The first is as a software that may be purchased and run on the seller's server system. The second is the system implemented in a software as a service embodiment. In this embodiment, the software may be stored in a cloud or similar network accessible server, and may be provided to the seller. The system may be accessible to a customer through the seller's website and would appear to be integrated into the seller's website and system.

In still another embodiment the system may be implemented as a volume auction system. In this system, a seller may wish to sell many of the same items quickly. For example, an electronics retailer may have 1000 digital cameras from a previous year they wish to sell. The retailer may use the system (either on their own, using the software as a service, or through an external website) to set a reserve price which is the lowest price that the retailer would be happy selling the products. The auction system may then begin auctioning the items beginning with a start price and decrementing to the reserve price. Users accessing the system in the volume auction know that there is a reserve price that may eventually be reached, but do not know what it is. As such, users may bid before the reserve is reached to ensure they receive the item, or may wait until the reserve is reached. Once the reserve is reached, it is possible that others may buy out the items before the user is able to bid. This conundrum builds excitement in the volume auction, and drives traffic to a website, app, or other network interface where the auction is taking place. Further, this embodiment allows users to get a good deal on a product that they may not otherwise get through traditional purchasing channels.

In a further volume auction embodiment, users may be permitted to buy more than one item with a single click. In this embodiment, users may be able to input a quantity of items they wish to purchase and when they enter their bid, it will automatically purchase that quantity. In some embodiments, this number may be limited. This embodiment allows bidder users to buy multiple units in the volume auction without slowing the auction down. In other words, the auction operates the same as if the user simply purchased one item, the auction and decrementing continues until the reserve is reached and/or the items are all sold. In a particular embodiment, if the quantity entered is greater than the items remaining, the bid will fail entirely. In another particular embodiment, if the quantity entered is greater than the items remaining, the bid will award the remaining items to the bidder.

In yet still another embodiment, the auction system may be implemented within a social networking service, either as an ‘app’ or integrated into the service. For example, Facebook® allows ‘apps’ that utilize the Facebook® interface and service. As such, the auction system may be implemented on Facebook® as an ‘app’. In other social networking services, a similar implementation could be used, or alternatively, the service could be adjusted to integrate the auction system. In these embodiments, a user wishing to sell an item may invite contacts, friends, or other users on the social network to attend the user's auction. The auction system may then be implemented as described herein with the bidders being users of the social networking service.

The system described herein allows an unlimited number of users to be participating in the auction. This is because the only communication from the user to the system is the point when the bid is entered by a user. Until then, the users are simply viewing the webpage or other network interface displaying the auction, and no back-and-forth communication takes place.

This is in contrast to other auctions such as live count-up auctions, in which all users must be constantly apprised of the bids of the other users, requiring the interface to be interactive with all users simultaneously-requiring the sending and receiving of continuous data between all parties. This raises a number of issues including losing users because of intermittent connections, limiting users because of a bandwidth limitation on the system host server, and a slower bidding process, among others.

Moreover, systems that keep all users apprised of continuous updates can not be run in browser-native environments. Instead, a special plug-in, application, or the like, is required. The present system may be configured to be run in a browser-native environment without the requirement of a special plug-in or application.

Further still, because of the present invention's ability for an unlimited number of users to participate in the auction, the system may be scalable to allow multiple auctions to be run at one time. This may apply to a server hosting multiple auctions simultaneously, as well as a user who is participating in multiple auctions simultaneously. The user may access the different auctions in different windows or interfaces, or may have them all open in the same window or view. Again, because of the system configuration, users and auctions do not take up substantial bandwidth, allowing multiple processes to be run simultaneously.

Another advantage of the system contemplated herein is the speed at which an auction may take place. For example, if a seller wishes to move a large quantity of the same or similar items (500 televisions for example) in a short period of time, an auction may be configured to attract a large number of user-participants, and may be configured to rapidly sell the items by bringing an item up for bid immediately after a previous item is sold. Further still, the decrement number and/or decrement rate may be set to decrease rapidly, causing users to have to buy rapidly. In one embodiment, the price may continue decrementing even once a user enters a bid—each user who enters a bid will receive the item until the lot is sold out. In an embodiment wherein the bid amount decreases to the reserve price, the system may be configured to allow users to all buy at that reserve price without resetting the auction until the item is sold out. Alternatively, the decrementing may begin again once a single item is purchased at the reserve price, the item bidding may re-start once the reserve is hit, or the price may continue counting down, but may inform the user that their bid was below the reserve if that is the case, and either cancel the auction or restart.

The speed at which the system contemplated herein can sell items is distinguished from traditional count-up auctions which require much longer to perform. A bid-up auction may take a particularly long time in the event of a bidding war. In contrast, the auction system contemplated herein is limited in its time frame to parameters set by the system based on starting bid, bid decrement, and decrement rate.

The system contemplated herein is truly an offer/price-driven, live auction system, because once a price for an item is selected by a user, that user wins the item (presuming another does not have a bid received by the system first). This is in contrast to many online auction systems which are time driven and not live. Further, the buyer knows if they have won the auction almost immediately, enhancing the user experience by providing instant gratification, among other things.

Because of the flexibility of the system, it may be implemented by a number of clients, including large scale sellers, large scale buyers, auctioneers, existing customers, new users, individual sellers and buyers, and the like.

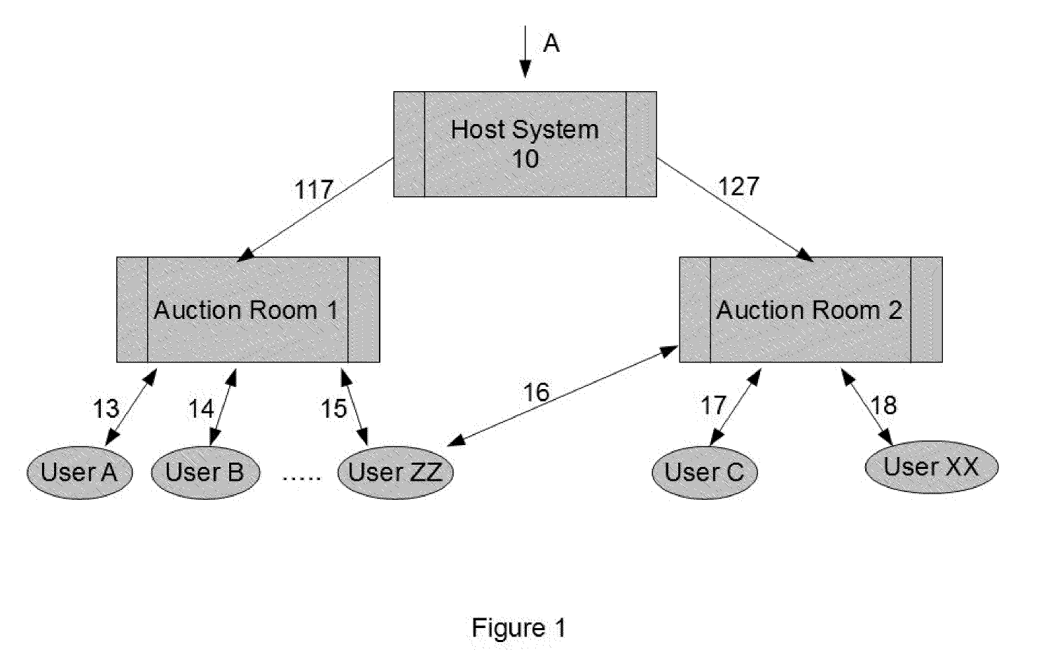

Turning now to FIG. 1, a chart of a host system providing interactive live auction rooms to a plurality of users is provided. Host system 10 may be any computerized system such as a server, personal computer, smart phone, tablet, or the like. The host system 10 is configured to receive inputs A to provide parameters for operation of two auction rooms 1, 2. However, it should be understood that host system 10 is capable of any number of auction rooms. Inputs A include information such as live auction parameters, auction items and details, and others, as discussed herein. Auction room 1 is set up and operated through host system 10 via data path 117. Auction room 2 is set up and operated through host system 10 via data path 127. Once the auction rooms 1, 2 are operational, they run as a live decrementing auction as discussed above. A plurality of users communicate with the auction rooms 1, 2 via computerized data paths 13-18. User ZZ is shown taking part in both auction rooms 1, 2, indicating that the user has two interfaces active on a computerized interface and is observing auctions as they take place via data paths 15 and 16.

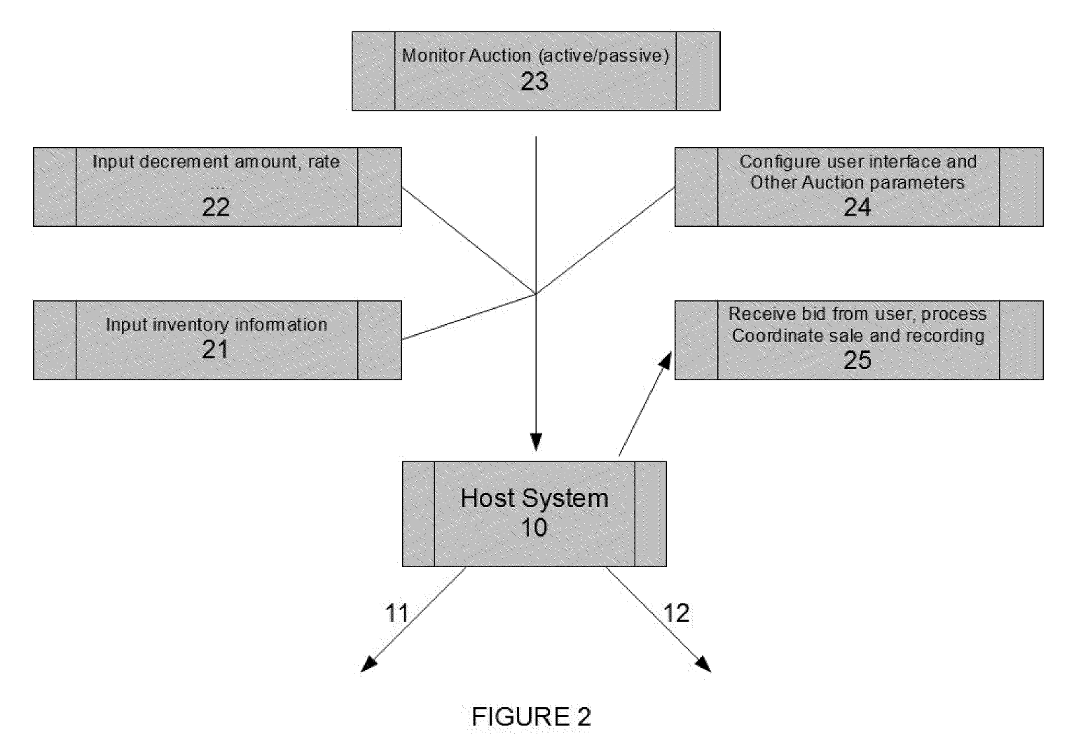

FIG. 2 provides a flow chart of an auctioneer side of an embodiment of this invention. Host system 10 receives a quantity of information that is provided by an auctioneer, or a user setting up an auction room. Information received may include, but is not limited to: inventory information 21, initial bid amount, decrement amount, and decrement rate 22, user interface configuration, and other auction parameters 24. Further, an auctioneer may monitor the auction 23, the items up for bid, item sales, pricing, decrement information, and the like. This monitoring may be active or passive, and may be fully or partially computer automated. The host system 10 may provide auction rooms (not shown) to a plurality of users via paths 11 and 12 based on this inputted information and auctioneer control. Further, host system 10 may receive a bid input from one of the users. This bid may be received from a user, processed, and a sale of the item may be coordinated and recorded via module 25 of the host system 10.

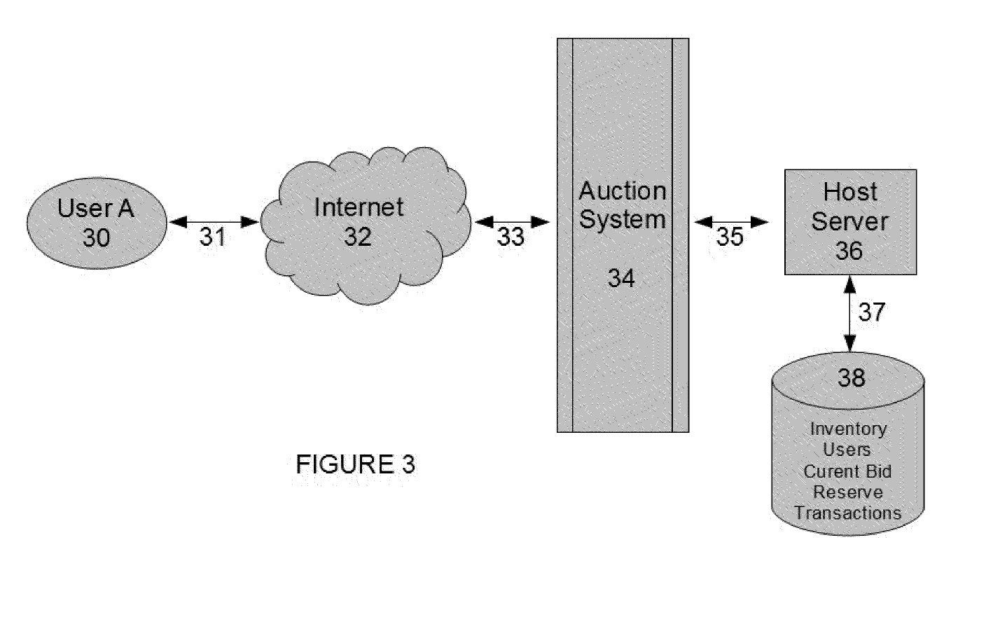

FIG. 3 provides a data flow chart of an embodiment of the system. User A 30 accesses auction system 34 through data paths 31 and 33, and internet 32. The auction system 34 is configured as the live decrementing auction discussed above. The auction is presented to computerized users as an auction room, and allows users to view the auction as it takes place, including decrementing item price, items up for bid shortly, details on the item up for bid and other items up for bid shortly, and the like. Further, the viewed auction allows users to input a bid, which is sent to the system. This input from the users is, in most embodiments, the only input a user provides to the system 34. The bid input is transmitted via path 35 to the host server 36. In addition to processing the bid input and hosting the auction system 34, host server 36 is in communication with a database 38 via path 37, containing information relating to the auction system 34. Information stored on the database 38 includes, but is not limited to: inventory for auctioning, system user information, current bid on an auctioned item, reserve number for the auctioning item, and transaction history information.

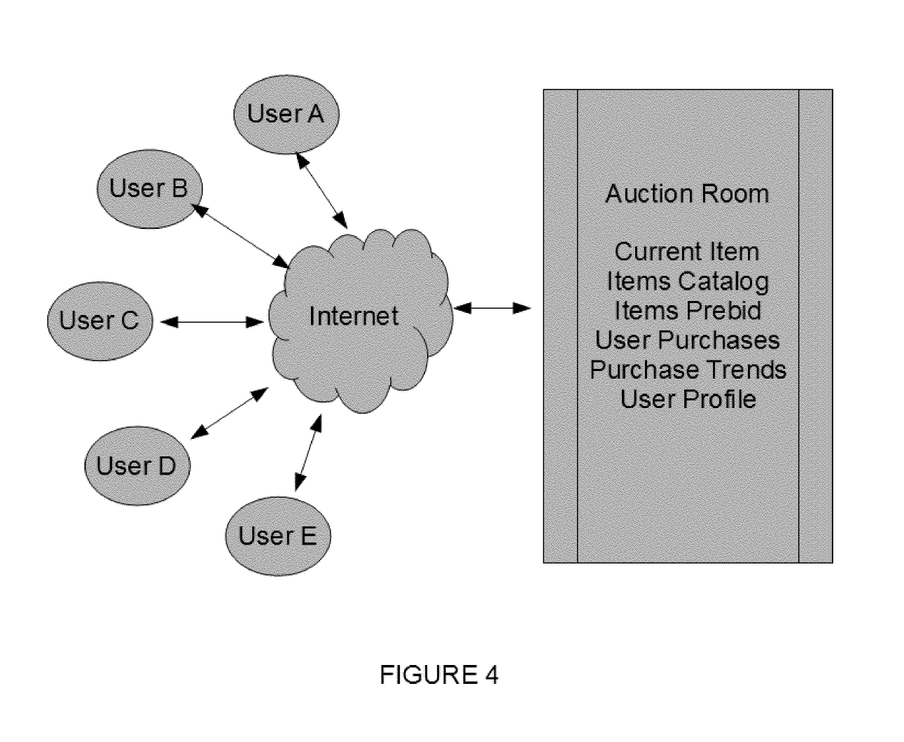

FIG. 4 provides another embodiment of a flow chart of the auction system. In this embodiment, users A-E are accessing a computerized auction room of the auction system via a computerized internet connection. When accessing the auction room, the users A-E may view, on their respective computerized interfaces, information including the current item up for bid, a catalog of items to be auctioned, items that the user has pre-bid on, prior purchase of the user, purchase trends of either that user or other users, and may access and edit their own user profile.

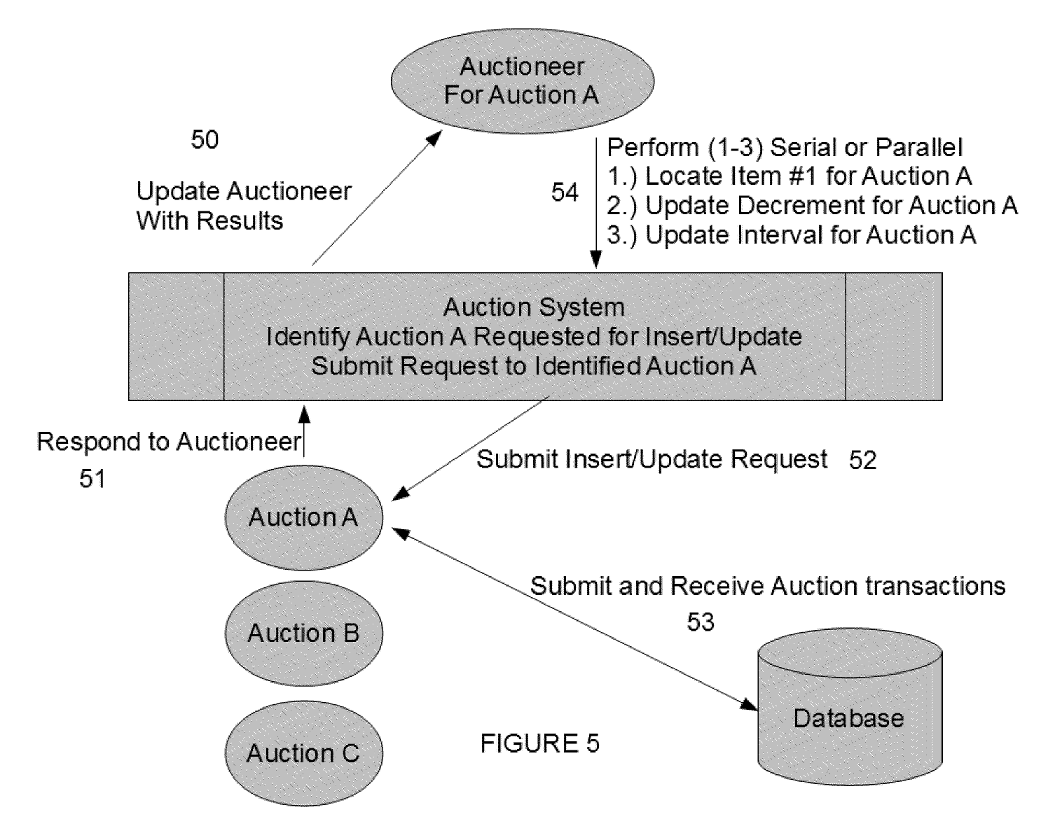

FIG. 5 provides a flow chart of an embodiment of the auction system contemplated herein. This view provides an example of auctioneer control of a plurality of auctions: Auctions A, B, and C. As an auction proceeds, each auction responds to the auctioneer 51. For example, when a user enters a bid, Auctioneer is provided with update information and results 50. Similarly, a database stores auction transaction information and auction inventory data. Transactions may be submitted and received between Auction A and the database via path 53.

Once the auctioneer is updated with results 50, the auctioneer may: 1) Locate item #1 for auction A, item 1 being the next item up for auction; 2) Update a decrement amount for new item 1 of auction A; and 3) Update a decrement interval for new item 1 of auction A. This information is provided to the auction system via path 54. These steps may be performed serially or in parallel, and may be performed manually, be automated or be partially automated by a computer. Once this information 54 is provided to the auction system, the system submits an insert/update request 52 to auction A to update the auction with the information 54 provided by the auctioneer. Similarly, the auctioneer may perform similar operations with Auction B and/or C. Further, additional auctioneers may control Auctions B and/or C.

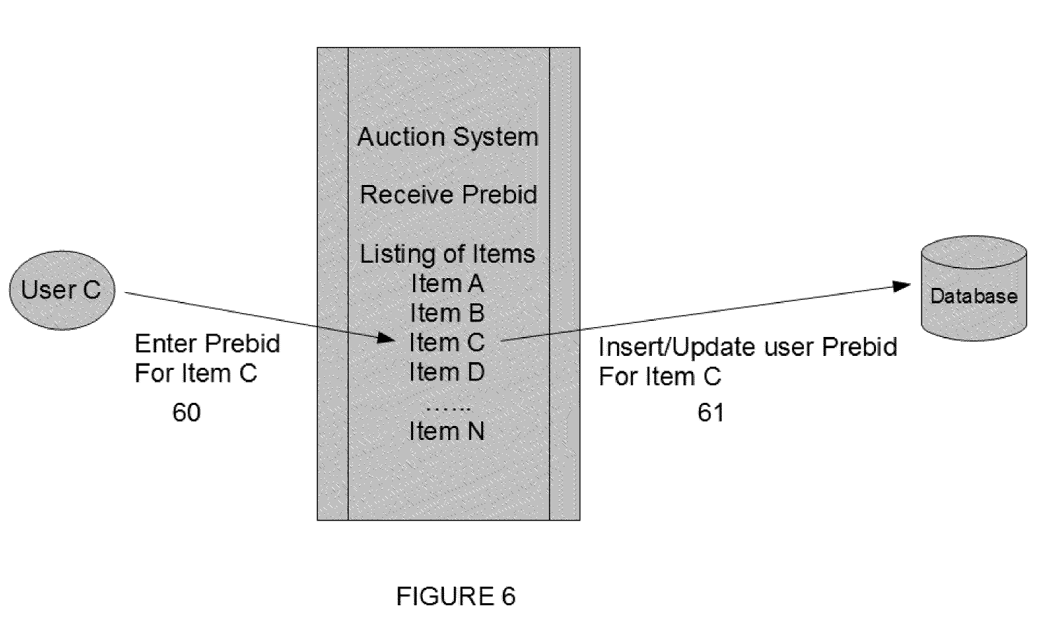

FIG. 6 provides a flow chart view of an embodiment of pre-bid operation of the auction system. In this embodiment, user C enters a pre-bid via path 60 for item C. User C being one of a plurality of users, and item C being one of a plurality of items to be auctioned by the auction system. The pre-bid may be entered by User C once he is accessing an auction room of the auction system via computerized interface. Once the auction system receives the pre-bid entered, it inserts the pre-bid information into a database or other memory via path 61. If a pre-bid is already entered by User C for item C, path 61 may enter an update to the user pre-bid.

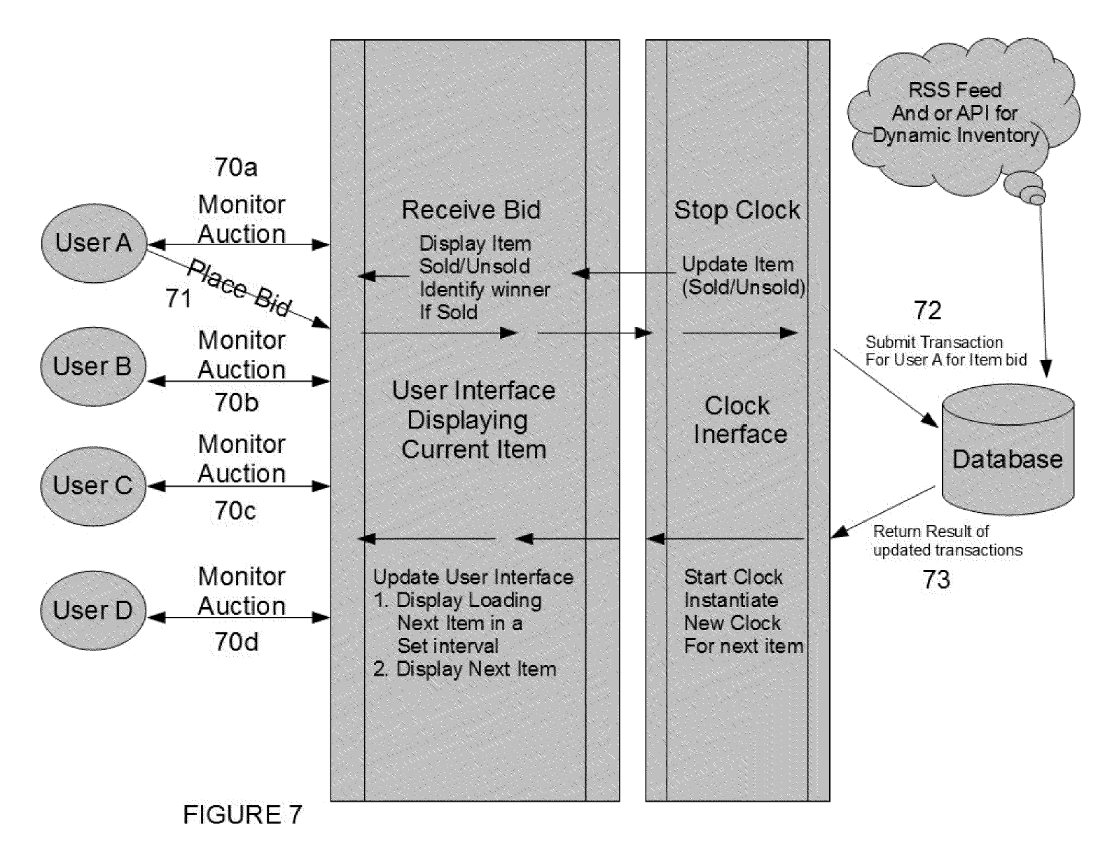

FIG. 7 provides a chart of an embodiment of the system in operation. The system involves a plurality of users, A-D monitoring an auction room. The auction room being managed and controlled by an auctioneer interface. A database is in communication with the auctioneer interface and auction room. The database provides the data relating to the auction and users involved including user information, auction information and inventory, transaction records, and the like.

Users A-D all monitor the auction as it progresses, in that they may all see the item up for bid, and the decrementing price. This monitoring is performed via paths 70a-d. Once one of the users views that the price of an item has decremented to a point that they are willing to buy the item at, a bid 71 is placed. The auction system receives this and submits the transaction to the database that User A bid on the item up for bid at the bid price, and stops the clock and the decrementing of the price and the auctioning of the item (except for a volume auction embodiments). The database then coordinates purchase and delivery. Additionally, in some embodiments, the winning user and/or winning bid may be identified to the other users. Further, the database returns a result of updated transactions via path 73 which results in an item update from auctioneer; updating of the clock interface for the new item up for auction, along with decrement amount and rate. This data is provided to users A-D by being displayed in the auction room, which has its user interface updated to display that a new item is coming up for bid and displaying the next item.

An RSS feed and/or an API is in communication with the database. The database may receive information from the RSS feed/API and use it as a dynamic inventory module to automatically populate and update the inventory of items to be auctioned.

While several variations of the present invention have been illustrated by way of example in preferred or particular embodiments, it is apparent that further embodiments could be developed within the spirit and scope of the present invention, or the inventive concept thereof. However, it is to be expressly understood that such modifications and adaptations are within the spirit and scope of the present invention, and are inclusive, but not limited to the following appended claims as set forth.

1. A live online auction method comprising the steps of:
providing an online auction room interface by at least one computer to a plurality of users, each of the plurality of users utilizing a computer to access the auction room, the auction room allowing access to an auction, providing a catalog to each of the plurality of users, and allowing bidding by the plurality of users, the catalog comprising a quantity of information relating to each of a plurality of items to be auctioned;
receiving a pre-bid by the at least one computer from one of the plurality of users on one of the plurality of items to be auctioned, and the pre-bid being received before the one of the plurality of items is brought up for bid;
controlling the auction taking place in the auction room interface by an auctioneer in computerized communication with the auction room;
initiating the auction by the auctioneer, wherein the step of initiating comprises the steps of:
bringing a first item of the plurality of items to be auctioned up for bid by the auctioneer;
configuring a decrement amount for the first item;
configuring a decrement rate for the first item;
configuring a starting price for the first item; and
initiating the decrementing of a price of the first item beginning at the starting price, wherein the decrementing price is displayed to the plurality of users accessing the auction room interface;
receiving a bid from a bidder-user of the plurality of users, the bid being a first bid input received from the plurality of users by the at least once computer providing the auction room, the step of receiving the bid being the only communication from the plurality of users to the at least one computer;
ending the bidding on the first item after the bid is received by the at least one computer;
awarding the first item to a bidder-user of the plurality of users whose bid was received;
providing an output by the at least one computer to the computer of a bidder-user of the plurality of users indicating that a bidder-user of the plurality of users has won the item;
continuing the auction after the bidding on the first item has ended.

2. The live online auction method of claim 1 wherein the step of continuing the auction comprises:
bringing a second item up for bid by the auctioneer;
configuring a second decrement amount of the second item;
configuring a second decrement rate of the second item;
configuring a second starting price of the second item; and
initiating the decrementing of a price of the second item beginning at the starting price, wherein the decrementing price is displayed to the plurality of users accessing the auction room.

3. The live online auction method of claim 1 wherein the step of controlling the auction room by the auctioneer is performed by a computer.

4. The live online auction method of claim 1 wherein the step of configuring a starting price comprises the steps of:
entering a first starting price; and
adjusting the first starting price automatically using the at least one computer upon receiving the pre-bid if the pre-bid received is a greater price than the first starting price, the adjusting comprising adding a percentage of the pre-bid received to the pre-bid value received and setting the added value as the start price.

5. The live online auction method of claim 1 further comprising the step of automatically adding to the plurality of items to be auctioned by a computerized dynamic inventory module in communication with the at least one computer providing the auction room, the dynamic inventory module automatically adding items to the plurality of items to be auctioned by the steps of:
accessing an application programming interface of a computerized sales service;
identifying a suitable item of the computerized sales service to be added to the plurality of items to be auctioned based on a comparison of data relating to the item to a criteria of the dynamic inventory module;
extracting a quantity of data relating to the suitable item from the application programming interface; and
inputting the quantity of data into the catalog.

6. The live online auction method of claim 1 further comprising the steps of:
providing a second auction room by the at least one computer to a second plurality of users, each of the second plurality of users utilizing a computer to access the second auction room, wherein the second plurality of users may comprise users of the plurality of users; and
controlling the second auction room by the auctioneer in computerized communication with the second auction room as well as the auction room.

7. The live online auction method of claim 1 wherein the step of providing the computerized auction room interface by at least one computer comprises providing the computerized auction room interface integrated into a social networking service website; and
selecting the plurality of users by the auctioneer from a group of subscribers to the social networking service.

8. The live online auction method of claim 1 wherein the plurality of items to be auctioned are provided from a single retailer;
wherein the step of providing a computerized auction room interface comprises providing a user interface integrated with a web site of the single retailer;
wherein the step of controlling the auction room by the auctioneer is performed by a human employee of the single retailer; and
arranging shipment of the one of the plurality of items to the one of the plurality of users whose bid was received using the at least one computer.

9. The live online auction method of claim 1 wherein the plurality of items comprises a lot of the same item, and wherein the step of initiating the auction further comprises the step of setting a reserve price that is the minimum price that each of the plurality of items may be sold at, the method further comprising the steps of:
allowing each of the plurality of users to buy more than one of the plurality of items at a time with a single bid;
stopping the decrementing of the price once the price reaches the reserve price and continuing the auction;
receiving a plurality of bids from the plurality of users; and
awarding at least one of the lot of the plurality of items to each user corresponding to one of the plurality of bids until the entire lot is sold.

10. The live online auction method of claim 1 further comprising the step of pre-qualifying each of the plurality of users based on an ability of the user to pay.

11. A system of live online auctioning comprising:
a host server providing an auction room interface accessible to a plurality of bidders, the auction room being a user interface making available information regarding an auction, the information regarding the auction comprising a price and price status of an item up for auction, and details regarding a plurality of items up for auction, the host server configured to control the auction as a price decrementing live auction;
a plurality of user computers in communication with the host server, each user computer configured to access the auction room provided by the host server and configured to provide a bid input to the host server;
wherein the host server is configured to receive auction control information, the auction control information comprising: descriptive information regarding the plurality of auction items, price decrement rate, price decrement amount, and starting price;
the host server configured to begin a sale of one of the plurality of items by beginning at the starting price and decrementing the price at the set decrement rate and amount, the decrementing price being communicated to the plurality of users via their computerized access to the auction room interface;
wherein one of the plurality of user computers is configured to provide a bid input to the host server, upon receipt of the bid input, the host server is configured to award the one of the plurality of items to the user of the one of the plurality of user computers, and bring a next of the plurality of items up for bid; and
wherein the host server is further configured to receive and record a pre-bid amount for one of the plurality of items up for auction from at least one of the plurality of user computers, the pre-bid amount automatically awarding the item to a user who input the pre-bid if the price of the item decrements to the pre-bid amount without being first purchased.

12. The system of live online auctioning of claim 11 wherein the host server further comprises a dynamic inventory module, the dynamic inventory module configured to access an application programming interface of an online sales service, identify an outside item meeting a criteria of the dynamic inventory module, and to import information regarding the outside item into the information regarding an auction of the host server; wherein the host server is configured to bring the outside item up for sale in the auction room.

13. The system of live online auctioning of claim 11 wherein the host server is further configured to provide a second auction room interface accessible to a second plurality of bidders.

14. The system of live online auctioning of claim 11 wherein the system receives the auction information from a computerized auctioneer and controls the auction automatically.

15. The system of live online auctioning of claim 11 wherein the auction room interface provided by the host server is integrated into an interface of a social networking website, the auction room interface being accessible only by subscribers to the social networking service.

16. The system of live online auctioning of claim 11 wherein the host server is controlled by a single retailer, and wherein the plurality of items to be auctioned are provided by a single retailer, the auction room interface being integrated into a user interface of a web site of the single retailer.

17. The system of live online auctioning of claim 11 wherein the plurality of items to be auctions comprises a lot of the same item;
wherein the host server is further configured to receive a reserve limit indicating a lowest price of each of the plurality of items up for auction, the server configured to decrement a price of each lot item until the reserve limit price is reached;
the host server configured to continue decrementing upon receiving the bid input from the one of the plurality of user computers and further configured to receive a second bid from a second of the plurality of user computers, awarding a second of the plurality of items to the user of the second of the plurality of user computers, and configured to continue receiving bid inputs and awarding items until the entire lot of the same item has been sold.

18. (canceled)

19. (canceled)

20. (canceled)

21. The live online auction method of claim 1 wherein the steps of initiating the auction by the auctioneer are performed by a seller-user of the plurality of users using a computerized interface, and wherein the first item of the plurality of items is being sold by the seller user.

22. The live online auction method of claim 21 further comprising the step of setting up the auction by the seller user, the seller-user performing the step of providing the online auction room interface using the at least one computer.

23. The live online auction method of claim 22 wherein at least one of the plurality of items to be auctioned belong to a second seller-user.
